(19) United States
(12) Patent Application Publication
(10) Pub. No.: US 2009/0133817 A1
(43) Pub. Date: May 28, 2009

(54) STENT MANUFACTURING METHODS

(76) Inventor: Patrick Sabaria, Saint Nom La Breteche (FR)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/282,727

(22) PCT Filed: Jun. 19, 2007
(86) PCT No.: PCT/IB07/01642

§ 371 Date: Sep. 12, 2008

Related U.S. Application Data
(60) Provisional application No. 60/814,533, filed on Jun. 19, 2006.
(60) Provisional application No. 60/854,075, filed on Oct. 25, 2006.

(51) Int. Cl. B32B 37/00; B29C 39/00

(52) U.S. Cl. 156/245; 264/225

(57) ABSTRACT

A novel method of manufacturing stents by use of molds (1101) made of a biocompatible, flexible material, preferably silicone. Some embodiments use silicone polymers; a two-dimensional, waffle mold; injection molds whereby the core of the injection mold is silicone polymer. In some embodiments, the stent polymer or particles of stent polymers are injected into the mold, around a cylinder of silicone, to form a three-dimensional stent. In some embodiments, particles of silicone polymer are mechanically forced into the negative spaces and then fused together to form the finished product. In other embodiments, metal stents or metal molds are used to manufacture a reverse mold. The reverse mold (901) is then used to create positive silicone molds. The silicone molds can subsequently be used by any means to make polymer stents, lending themselves to automation.

### BACKGROUND OF THE INVENTION

The use of stents in various surgical, interventional cardiology, and radiology procedures has quickly become accepted as experience with stent devices accumulates and as the advantages of stents become more widely recognized. Stents are often used in body lumens to maintain open passageways such as the prostatic urethra, the esophagus, the biliary tract, intestines, and various coronary arteries and veins, as well as more remote cardiovascular vessels such as the femoral artery.

Stents are often used to treat atherosclerosis, a disease in which vascular lesions or plaques consisting of cholesterol crystals, necrotic cells, lipid pools, excess fiber elements, and calcium deposits accumulate in the walls of an individual's arteries. One of the most successful procedures for treating atherosclerosis is to insert a deflated balloon within the lumen, adjacent the site of the plaque or atherosclerotic lesion. The balloon is then inflated to put pressure on and “crack” the plaque. This procedure increases the cross-sectional area of the lumen of the artery. Unfortunately, the pressure exerted also traumatizes the artery, and in 30-40% of the cases the vessel either gradually renarrows or recloses at the locus of the original stenotic lesion. This renarrowing is known as restenosis.

A common approach to prevent restenosis is to deploy a metallic stent to the site of the stenotic lesion. Although metallic stents have the mechanical strength necessary to prevent the retractile form of restenosis, their presence in the artery can lead to biological problems including vasospasm, compliance mismatch, and even occlusion. Moreover, there are inherent, significant risks from having a metal stent permanently implanted in the artery, including actual erosion or destruction of the vessel wall. The stents may also migrate on occasion from their initial insertion location raising the potential for stent-induced blockage. Metal stents, especially if migration occurs, cause irritation to the surrounding tissues in a lumen. Also, since metals are typically much harder and stiffer than the surrounding tissues in a lumen, this may result in an anatomical or physiological compliance mismatch, thereby damaging tissue or eliciting unwanted biologic responses. In addition, the constant exposure of the stent to the blood can lead to thrombus formation within the blood vessel. Stents also allow the cellular proliferation associated with the injured arterial wall to migrate through the stent mesh, where the cells continue to proliferate and eventually lead to the narrowing of the vessel. Further, metal stents typically have some degree of negative recoil. Finally, metallic stents actually prevent or inhibit the natural vascular remodeling that can occur in the organism by rigidly tethering the vessel to a fixed, maximum diameter and shape.

Because of the problems of using a metallic stent, others have recently explored use of bioabsorbable and biodegradable materials for stents. The conventional bioabsorbable or bioresorbable materials from which such stents are made are selected to absorb or degrade over time. This degradation enables subsequent interventional procedures such as restenting or arterial surgery to be performed. It is also known that some bioabsorbable and biodegradable materials tend to have excellent biocompatibility characteristics, especially in comparison to most conventionally used biocompatible metals. Another advantage of bioabsorbable and biodegradable stents is that the mechanical properties can be designed to substantially eliminate or reduce the stiffness and hardness that is often associated with metal stents. This is beneficial because the metal stent stiffness and hardness can contribute to the propensity of a stent to damage a vessel or lumen. Examples of novel biodegradable stents include those found in U.S. Pat. No. 5,957,975, which is incorporated by reference in its entirety.

Many methods of stent manufacture have been attempted before. For instance, Agrawal et al. (1992) found that biodegradable polymers may be extruded into monofilaments that then may be used for construction of the stents. See, Biomaterials, 13(3): pgs. 176 -87. This method, however, may lead to the polymer being thermally damaged during the extrusion process.

Still others have attempted formation of stents by flotation. For instance, Rajasubramamian et al. (1994) found they could manufacture polymeric stents by dissolving the polymeric mixture in an organic solvent and “floating” the polymer. See, ASAIO, pgs. M584-89. The liquid polymer is then sprayed on a water surface, whereby the solvent evaporates and leaves the polymer film on the water surface. The film is cured in a vacuum furnace at 45° C. for over 24 hours. This method poses many problems because the film is often uneven, susceptible to process fluctuations, and the increased temperature of the curing step can sometimes detrimentally affect the mechanical properties of the stent. Further, the polymer is often subject to laser cutting to form the struts of the stent, which is not only time consuming but which further increases sharp edges of the stent and can generate chemically reactive sites, both of which can lead to increased thrombogenesis.

Use of molds for stent formation would be an ideal method to make a stent. Molds can potentially make stents faster and would likely result in a stent with uniform thickness. Others have attempted use of molds, for instance Schmitz et al. (1996) coated a solid cylinder with layers of polymer solution, whereby solvents in the solution evaporated to allow the polymer to precipitate. See, U.S. Pat. No. 5,935,506. There are, however, numerous problems with conventional molds. One problem is that the stent is tightly wrapped upon the mold and therefore is likely to be damaged as it is removed from the mold. A related problem is the inability of the formed stent to release from the mold, thereby greatly limiting potential shapes that can be created. Another problem is that the resulting stent is a smooth cylinder and as such will still need to be cut into a pattern of struts by, for instance, a laser. The additional cuts may result in increased irregular or sharp edges, increased reactive groups on the stent, and increased cost and time to manufacture the stent.

Previous attempts to use molds to manufacture stents have not been completely successful. Typically, the stent strongly adheres to the mold and removal of the stent can damage the shape and mechanical properties of the stent. This can severely limit the shape and design of the stent. Accordingly, it is desirable to find novel stent manufacturing methods that are faster, cheaper, and require minimal cuts. Further, it is desirable to find novel stent manufacturing methods that lend itself to automation. The inventors have found a novel method to manufacture a stent by use of various types of molds.

### SUMMARY OF THE INVENTION

The inventors have discovered a novel method of manufacturing stents by use of molds. In preferred embodiments, the inventors manufacture a mold made of a biocompatible, flexible material. Preferably, the biocompatible, flexible material is silicone. While the various embodiments set forth use silicone polymers in an exemplary manner, one skilled in the organic polymer art would immediately recognize other flexible materials can also be utilized.

Certain preferred embodiments utilize what is best described as a two-dimensional, waffle mold where the mold is made of a silicone polymer. The resulting two-dimensional polymer sheet may be easily removed by stretching or twisting the mold. The polymer sheet made by the waffle mold is then rolled into a cylinder and the edges are glued or welded together to form a stent. Curved forms of this mold are also contemplated and can simplify rolling the final product into a cylinder.

Certain other preferred embodiments utilize forms of injection molds whereby the core of the injection mold is silicone polymer. The stent polymer or particles of stent polymers are injected into the mold, around a cylinder of silicone, to form a three-dimensional stent. In some embodiments, particles of silicone polymer are mechanically forced into the negative spaces and then fused together to form the finished product. The stent is removed from the mold and silicone cylinder by applying outward force to the ends or edges of the cylinder of silicone, stretching the silicone and reducing its diameter to permit removal of the stent.

In certain embodiments, metal stents or metal molds are used to manufacture a reverse mold. The reverse mold is then used to create positive silicone molds. The silicone molds can subsequently be used by any means to make polymer stents. These methods have the benefit of lending themselves to automation. Certain embodiments utilize the differential temperature expansion coefficients of the silicone polymer and the stent forming polymer to improve the release characteristics. Air jets can also be advantageously employed to release the final stent as can low density forms of silicone polymer containing substantial amounts of compressible air space.

### SUMMARY OF FIGURES

FIG. 1 depicts a mold in accordance with a preferred embodiment of the present invention.

FIG. 2 depicts a flat, two-dimensional stent made by a mold in accordance with a preferred embodiment of the present invention.

FIG. 3 depicts a flat, two-dimensional stent rolled into a cylinder structure and glued in accordance with a preferred embodiment of the present invention.

FIG. 4 depicts the resulting stent made by the mold of FIG. 1 in accordance with a preferred embodiment of the present invention.

FIG. 5 depicts the base of another mold in accordance with a preferred embodiment of the present invention.

FIG. 6A depicts the base of a mold with a stent placed upon the base to form a pattern in accordance with a preferred embodiment of the present invention.

FIG. 6B depicts a method of placing the stent upon the base to form a pattern in accordance with a preferred embodiment of the present invention.

FIG. 7 depicts a pattern placed within a casting chamber in accordance with a preferred embodiment of the present invention.

FIG. 8 depicts a cut of a cross-section of the casting chamber of FIG. 7 in accordance with a preferred embodiment of the present invention.

FIG. 9 depicts the resulting negative mold made by the casting chamber of FIGS. 7 and 8 in accordance with a preferred embodiment of the present invention.

FIG. 10 depicts a positive mold made by the negative mold of FIG. 10 in accordance with a preferred embodiment of the present invention.

FIG. 11 depicts a diagrammatic, perspective view of using the positive mold of FIG. 10 to make polymeric stents in accordance with a preferred embodiment of the present invention.

FIG. 12A depicts the positive mold with a newly formed stent thereupon in accordance with a preferred embodiment of the present invention.

FIG. 12B depicts a method of removing the newly formed stent from the positive mold in accordance with a preferred embodiment of the present invention.

FIG. 13 depicts an injection mold in accordance with a preferred embodiment of the present invention.

FIG. 14 depicts a cut of a cross-section of the injection mold of FIG. 13 in accordance with a preferred embodiment of the present invention.

FIG. 15A depicts the base of a mold with a stent placed thereupon in accordance with a preferred embodiment of the present invention.

FIG. 15B depicts a cut of a cross-section of the mold of FIG. 15A in accordance with a preferred embodiment of the present invention.

FIG. 16A depicts a pattern placed within a casting chamber in accordance with a preferred embodiment of the present invention.

FIG. 16B depicts a positive mold made from the casting of FIG. 16A in accordance with a preferred embodiment of the present invention.

### DETAILED DESCRIPTION

### Definitions

“Bioresorbable polymer” as used herein refers to a polymer whose degradation by-products can be bio-assimilated or excreted via natural pathways in a human body.

“Acetone bath” as used herein refers to a bath comprising one or more solvents, where the solvents may be acetone, chlorinated hydrocarbons, and/or ketones. Certain preferred embodiments of the polymeric stent fabrication method include partially or fully immersing the polymeric stent into the acetone bath.

“Crimping” as used herein refers to a process that involves pressing, preferably radially, on a polymeric cylindrical device having slits, or openings in the wall thereof to allow a decrease in the diameter of the device without substantially affecting the thickness of the wall or struts of the cylindrical device. Such process, typically also results in an increase in length of the cylindrical device.

“Degradable polymer” or “biodegradable polymer” as used herein refers to a polymer that breaks down into monomers and oligomers when placed in a human body or in an aqueous solution and maintained under conditions of temperature, osmolality, pH, etc., that mimic physiological media preferably without involving enzymatic degradation to minimize the risk of triggering the antigen antibody defense system of the human body.

“Final predetermined shape and diameter” as used herein refers to the desired diameter, length, design and wall thickness of a stent that has been deployed to a target site in a vessel, particularly a blood vessel, duct, or tube in a mammalian subject, particularly a human subject.

“Negative recoil” as used herein refers to a decrease in the size or diameter of an expanded stent after initial deployment.

“Positive recoil” as used herein refers to an increase in the size or diameter of a stent that has been educated to have a desired final diameter but has not been fully expanded to the desired final diameter.

“Relaxation-related recoil” as used herein refers to the slow change in dimensions of a polymeric device due to a time-dependent slow rearrangement of molecule conformations according to the well-known behavior of viscoelastic polymeric matters. Such rearrangement is due to thermal agitation that slowly leads the polymeric material to a thermodynamic equilibrium typical of the storage conditions when it has been processed under different environmental conditions. Relaxation is very slow below the polymer's glass transition temperature, Tg.

“Tg” or “glass transition temperature” as used herein refers to the temperature at which a polymer changes from a rubbery state to a glassy state and vice versa.

The inventors have discovered a novel method of manufacturing stents by use of molds. Previous attempts to use molds to manufacture stents have failed. Typically, the stent strongly adheres to the mold and removal of the stent can damage the shape and mechanical properties of the stent. As such, the inventors manufacture a mold made of a biocompatible, flexible material. Preferably, the biocompatible, flexible material is silicone.

The molds contemplated by the inventors may be a two dimensional, waffle mold where the mold is made of a biocompatible, flexible material. The resulting two-dimensional polymer sheet may be easily removed by stretching or twisting the mold. The sheet made by the waffle mold is then rolled into a cylinder and the edges are welded together to form a stent. Other molds contemplated by the inventors include injection molds whereby the core of the injection mold is a biocompatible, flexible material. The polymer is injected into the mold, either as a liquid polymer or as a fine powder of polymeric material, around a cylinder of biocompatible, flexible material, to form a three-dimensional stent. The stent can be removed from the mold by applying outward force to the edges of the cylinder of biocompatible, flexible material, stretching the silicone and reducing its diameter. Other removal methods can utilize the differing temperature expansion coefficients of the stent polymer and the silicone polymer as well as air jets.

Other embodiments contemplated by the inventors include use of metal molds to manufacture a reverse mold. The reverse mold is then used to create positive biocompatible, flexible material molds. The biocompatible, flexible material molds are used by any means to make polymer stents. These methods have the unexpected result of creating methods that lend to superior forms of automation.

### I. Exemplary Stent Fabrication and Properties

The stents may be formed from any biodegradable, biocompatible, bioresorbable polymer, preferably a thermoplastic polymer. As used herein, a bioresorbable polymer is one whose degradative products are metabolized in vivo or excreted from the body via natural pathways. Preferably, the stent of the present assembly is formed from a degradable and bioresorbable polymer having a Tg at least 8 degrees above 37° C., preferably at least 20 degrees above 37° C. The polymer of the stent can be a homopolymer or a copolymer. Preferably, the stent is formed from a thin layer of one or more amorphous, bioresorbable polymers, i.e., the polymers used to form the stent preferably are not crystalline at room temperature. It is also preferred that the polymers used to form the stent do not generate crystalline residues upon degradation in vivo. The chains of the stent forming polymer may or may not be cross-linked. Light cross-linking, may be preferred if thermal and viscoelastic characteristics that allow education, crimping, and deployment of the device are sufficiently maintained.

Appropriate biodegradable polymers for the stent may include, but are not limited to, poly(L-lactide), polyglycolide, poly(D,L-lactide), copolymers of lactide and glycolide, polycaprolactone, polyhydroxyvalerate, polyhydroxybutyrate, polytrimethylenecarbonate, polyorthoesters, polyanhydrides, and polyphosphazenes. Examples of the types of polymers that form preferred embodiments for the stent of the present invention include, but are not limited to, lactic acid-based stereocopolymers (PLAx copolymers composed of L and D units, where X is the percentage of L-lactyl units) (55<Tg<60), copolymers of lactic and glycolic acids (PLAxGAy, where X, the percentage of L-lactyl units, and Y, the percentage of glycolyl units, are such that the Tg of the copolymer is preferably above 45° C.), and Poly(lactic-co-glycolic-co-gluconic acid) where the OH groups of the gluconyl units can be more or less substituted (pLAxGayGLx, where X, the percentage of L-lactyl units, and Y, the percentage of glycolyl units, and Z the percentage of gluconyl units are such that the Tg of the terpolymer is preferably above 45° C.). Other suitable polymers include, but are not limited to, polylactic acid (PLA), polyglycolic acid (PGA) polyglactin (PLAGA copolymer), polyglyconate (copolymer of trimethylene carbonate and glycolide, and a copolymer of polyglycolide or lactide acid or polylactic acid with ε-caprolactone), provided that the polymer has a glass transition temperature, Tg, of preferably at least 45° C. or greater.

In one preferred embodiment, the stent comprises a polylactic acid stereocopolymer produced from L and DL lactides. The polymer is designated herein as “PLAX” where X represents the percentage of the L-lactic acid units in the mixture of monomers used to prepare the lactides. Preferably X is in the range of 10 to 90, more preferably 25 to 75. In another preferred embodiment, the stent comprises a poly-lactic acid, glycolic acid copolymer produced from L and DL lactides and glycolides. The polymer is designated herein as “PLAXGAY” where Y represents the percentage of glycolic acid units in the mixture of monomers used to prepare the copolymers. Preferably, the copolymers do not contain glycolyl repeating units since such units are known to be more inflammatory than lactyl repeating units. Preferably, the polymers are prepared using Zn metal or Zn lactate as initiator. To ensure good initial mechanical properties of the stent, the molecular weight of the polymer in the region having the second in vivo lifetime is preferably above 20,000 daltons, more preferably 100,000 daltons or larger. The polydispersity, I=Mw/Mn, is preferably below two and preferably should not greatly reflect the presence of low molecular weight oligomers smaller than 2,000 daltons as determined by size exclusion chromatography.

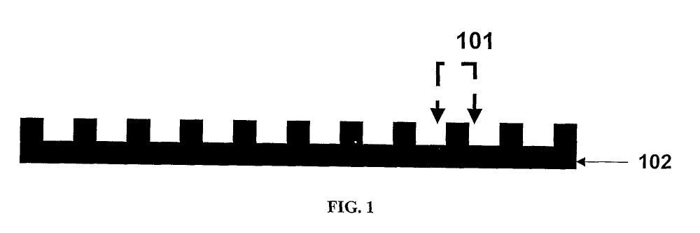

In one embodiment of the invention, a two-dimensional polymer sheet is rolled into a three-dimensional cylindrical stent. In one preferred embodiment as depicted in FIG. 1, the polymer sheet is formed by use of a waffle mold. The waffle mold 102 comprises open channels 101. The waffle mold 102 may be made of any material that is flexible. Preferably, the mold is formed of a biocompatible material so that any of said material that breaks off or contaminates the stent will not detrimentally affect the patient. Preferably, the mold is made of silicone. The waffle mold 102 comprises open channels 101 that contain the preferred pattern of the stent. It is contemplated that the biodegradable polymer is heated until it is above the glass transition temperature; preferably, the polymer is liquid; however, formation from polymer grains is possible. The polymer is then placed within the open channels 101 of the waffle mold 102. The placement of the polymer within the mold can occur by pouring the polymer into the mold, pressing the polymer into by physical or atmospheric pressure, or by any other means. Once the open channels 101 are filled with the polymer, the polymer is processed and allowed to cool and reharden. As the waffle mold 102 is a flexible material, the stent may be easily released from the mold by physical manipulation of the mold such as pulling on two lateral ends or twisting.

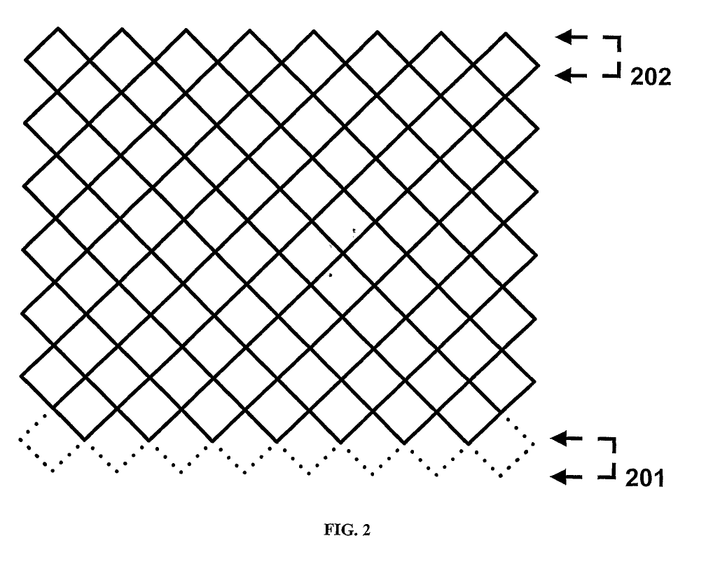

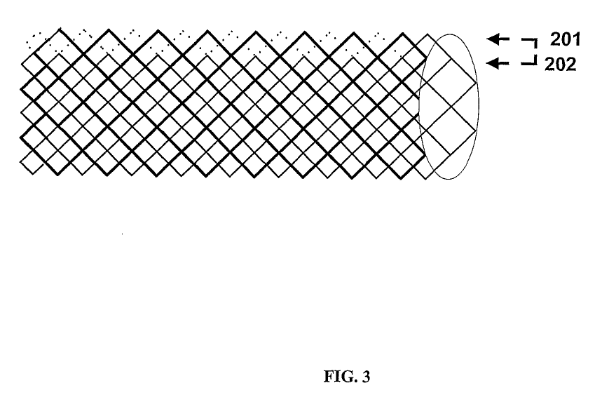

FIG. 2 depicts a flat, two dimensional sheet of polymer released from the mold, where the pattern of the mold has resulted in a pattern of struts. The two dimensional sheet will have two ends 201 and 202 which are patterned such that they are compatible for gluing or welding together. In FIG. 3, the flat two-dimensional sheet is rolled into a three-dimensional cylindrical shape such that edges 201 and 202 touch one another. Edges 201 and 202 are then glued together. Methods of gluing may include heat welding, chemical gluing, physical crimping, or any other means as long as edges 201 and 202 are secured together to form the cylindrical shape.

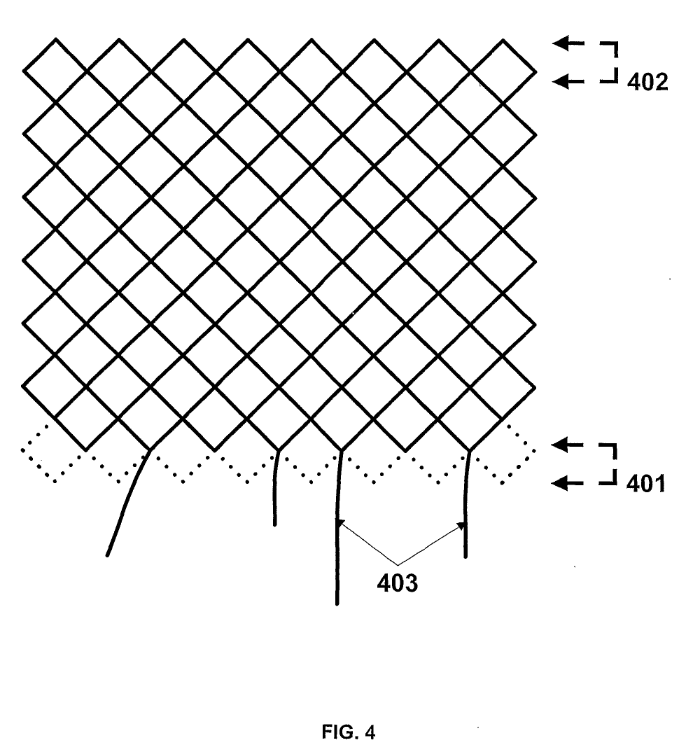

In one preferred embodiment depicted in FIG. 4, the sheet formed by the two-dimensional mold has at least one edge 401 having one or more tongues or strings 403 projecting from the edge. Generally, the tongues or strings 403 help add support the glued edges and help prevent the three-dimensional cylinder from unrolling into a two-dimensional sheet. The tongues or strings 403 are placed upon the edges 401 that will be glued together. These tongues and strings 403 of edge 401 are then weaved among the struts of the second parallel edge, edge 402. The tongues or strings 403 that project from the edge in this embodiment are in the same two-dimensional plane as the sheet; however, the tongues or strings may be at any angle within that two-dimensional plane. For instance, the tongues or strings may be at a 45 or 90-degree angle to the edge 401. The degree angle will be determined by the anticipated weaving of the tongue or string through the struts.

In another preferred embodiment, the stent is a formed by a two-dimensional mold that has one edge having one or more slots and tongues comprising a catch or locking mechanism proximate the longitudinal edge thereof. The cylindrical element is formed by inserting a portion of the tongue through the slot to provide a cylindrical element having a first reduced diameter configuration. Following deployment, the cylindrical element is in a second expanded diameter configuration wherein the distal catch mechanism engages the inner surface of the head and prevents radial collapse or recoil of the polymeric stent.

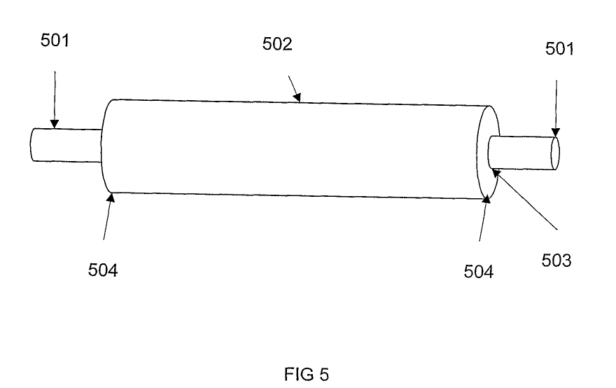

In another preferred embodiment, a mold created by use of the core is presented in FIG. 5. The core comprises a cylindrical rod 501, preferably metal. Placed upon that rod 501 is a cylinder 502 having two edges 504. The inner diameter 503 of the cylinder 502 should be very close to the outer diameter of the metal rod 501 such that there is minimal space between the cylinder 502 and metal rod 501. The minimal space prevents the cylinder 502 from rotating on the rod 501. The cylinder 502 may be made of any material, but in one preferred embodiment the material is silicone.

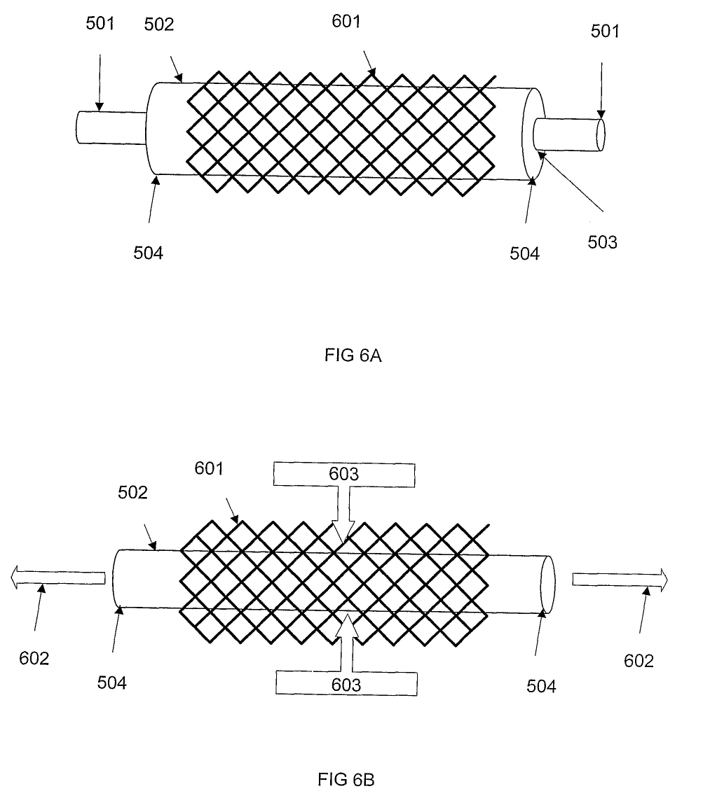

In FIG. 6A, a three-dimensional stent 601 having a pattern of struts desired for the final stent is placed upon the cylinder 502. The stent 601 may be made of any material that is resistant to high heat but preferably, the stent is metal. The inner diameter of the stent 601 should by very close to the outer diameter of the cylinder 502 such that there is minimal space between the inner diameter of the stent and the outer diameter of the silicone cylinder. The cylinder 502, rod 501 and stent 601 are together called a “pattern”. In one preferred embodiment of FIG. 6B, the material of the cylinder 502 is silicone. In this case, the rod 501 is removed. The stent 601 is placed on the cylinder 502 by applying outward force 602 on the edges 504 such that the length of the cylinder 502 increases. The increase in length increases the transverse forces on the radius of the cylinder 502 to decrease the radius as the outward force 602 increases. The stent 601 is then slipped onto the cylinder 502. The outward force 602 is removed such that the radius of the cylinder 502 decreases to form the pattern of FIG. 6A.

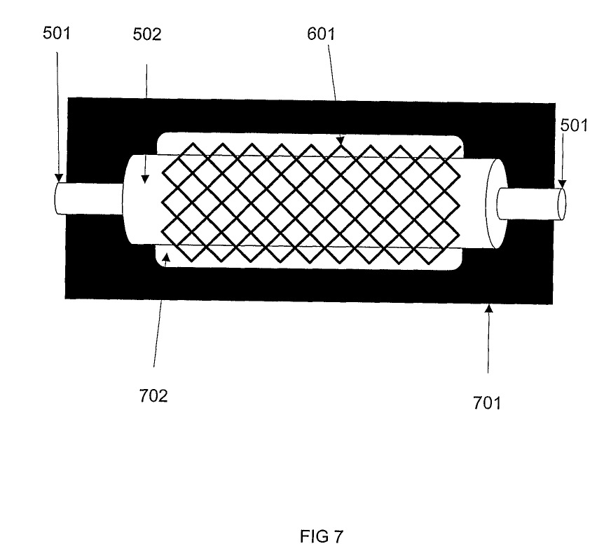

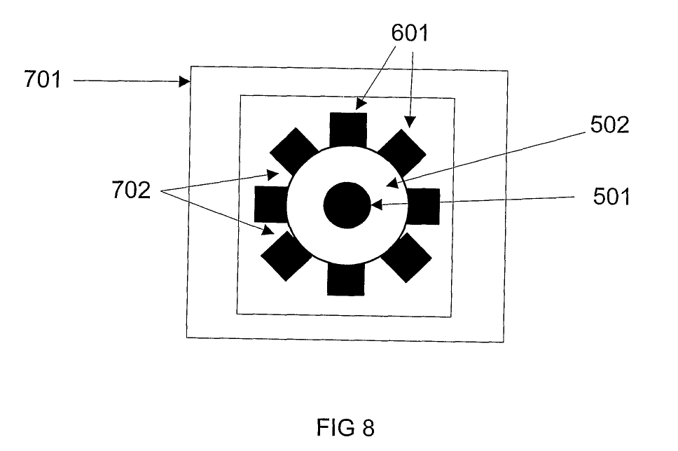

In FIG. 7, the pattern is then placed in a casting chamber 701. The casting chamber 701 is a device that allows a liquid material to be pored into the space 702 around the pattern to make a reverse mold of the stent. FIG. 8 a cross-section of the pattern in the casting chamber 701. The cross-section shows the cylinder 502 is located on top of the rod 501. The stent 601 is located on top of the cylinder 502. To create an impression of the desired casting, a liquid casting material is poured into the casting chamber 701. The material fills all of the spaces 702, thereby making a reverse mold of the stent 601. Once the casting material in the space 702 has cooled and hardened, the casting chamber 701 is opened and the “pattern” is removed. The resulting casting material is a reverse mold that may now be used to make biodegradable stents having the pattern of the metal stent.

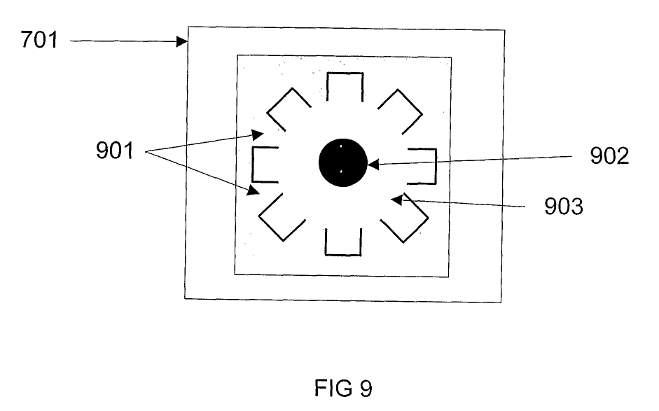

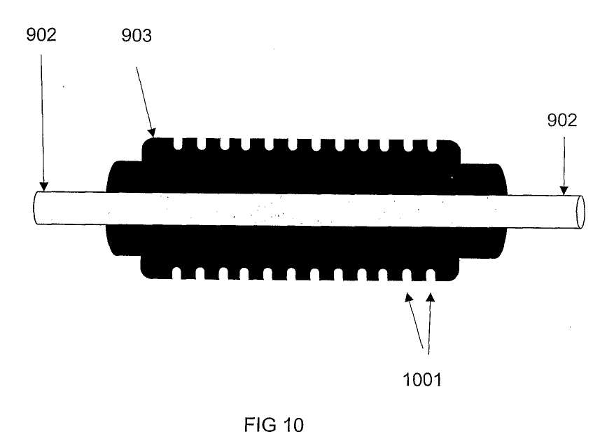

FIG. 9 shows a cross-section of the reverse mold 901 in a casting chamber 701. To use the reverse mold 901, a cylinder 902 is placed within the reverse mold 901. Liquid silicone is poured into the spaces 903 between the reverse mold 901 and the metal cylinder 901. Once the silicone has hardened, the casting chamber 701 and reverse mold 901 are removed. A different view of the resulting positive mold formed from the hardened silicone 903 is depicted in FIG. 10. FIG. 10 shows a perspective view of the mold. The mold consists of the cylinder 902 with the silicone mold 903 thereupon. The silicone mold 903 is a cylinder with spaces 1001 upon the outer diameter. The spaces 1001 form the pattern of the desired stent.

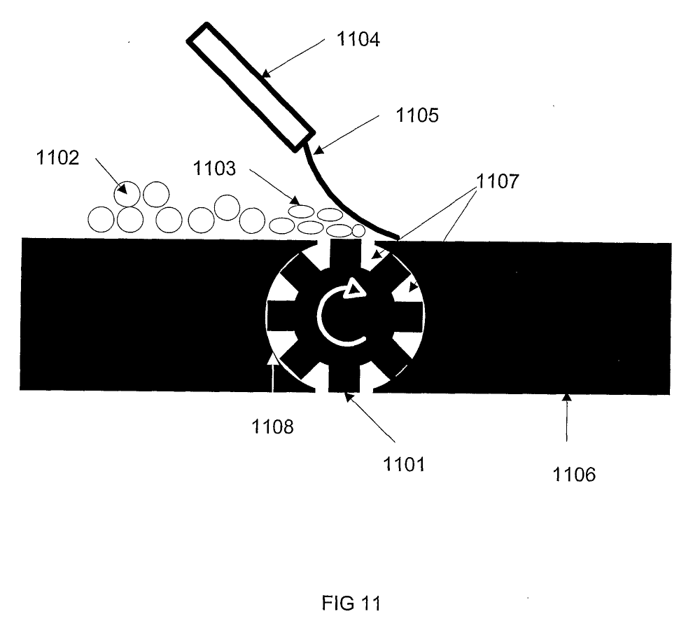

The resulting mold of FIG. 10 is capable of producing stents very quickly. One method of producing stents is depicted in the perspective view of a fabrication area in FIG. 11. In this method, the positive mold of FIG. 11 is depicted as 1101. Biodegradable polymer 1102 is heated such that it melts. The polymer can be in any initial form, including but not limited to beads, sheets, extruded polymer, and the like. The polymer can be heated by any heating element such as a heating element in the device 1106, in the spatula 1105 of tool 1104, hot air, and the like. As the polymer 1102 melts the liquid polymer 1103 falls into the spaces 1107. The spatula 1105 of the tool 1104 helps to guide the liquid or beads into the spaces 1107. The mold 1101 rotates in a clockwise or counter-clockwise manner, as appropriate. As the mold 1101 rotates, the spaces 1107 fill with the liquid polymer 1103 until the spaces 1107 are filled. The devices 1106 are designed such that they contain one edge with a concave curve 1108, whereas if the concave curve 1108 was a complete circle, it would have a diameter very close to the outer diameter of the mold 1101. The concave curve 1108 should be designed such that there is sufficient space between the concave curve 1108 and mold 1101 for the mold to freely rotate, but the space between the concave curve 1108 and the mold 1101 should be such that minimal liquid polymer is trapped between the outer diameter of the mold 1101 and inner diameter of the concave curve 1108. The liquid polymer 1103 is allowed to cool and harden. The mold 1101 with the polymer hardened thereupon is then removed from the fabrication area. It is further contemplated that the cylinder 902 of the mold may be heated or cooled to assist in the stent production.

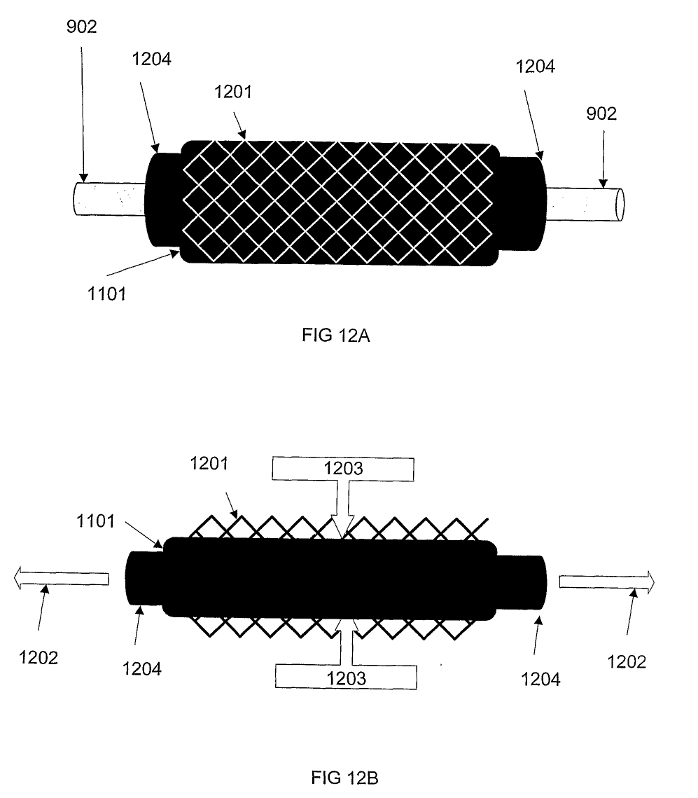

In FIG. 12A, once the stent polymer has hardened, the stent polymer has conformed into a stent configuration 1201 on the silicone mold 1101. To remove the newly created stent 1201, the cylinder 902 is removed from the silicone mold 1101. In FIG. 12B, outward force 1202 is applied to the edges 1204 of the silicone mold 1101 such that the silicone is stretched and the length of the silicone mold increases. The increase in length of the silicone mold will cause an increase in transverse force 1203 to decrease the radius of the mold 1101. The stent 1201 can then be safely removed from the mold 1101 without adversely manipulating the stent 1201.

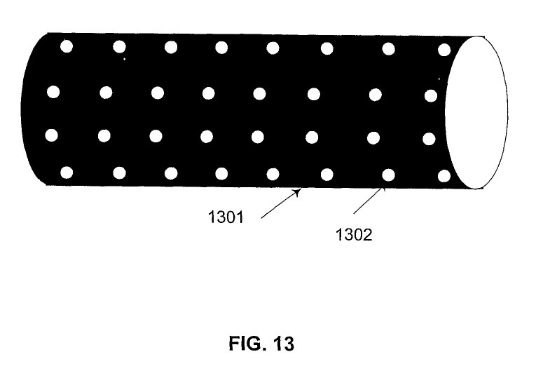

In another preferred embodiment, the stent may also be formed by molding or injection molding of the biodegradable material into a three-dimensional mold. In FIG. 13, a three-dimensional mold 1302 is designed so that the biodegradable material may be injected at one or more areas along the mold 1302. In this embodiment, the biodegradable polymer is heated until it is above the glass transition temperature. The polymer is then injected in one or more places into the mold. The polymer is allowed to cool and harden within the mold.

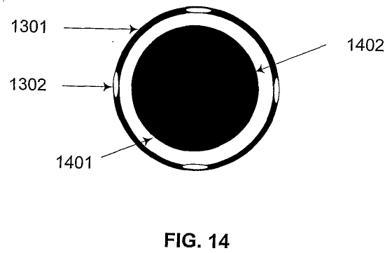

FIG. 14 depicts a cut of a cross-section of the injection mold of FIG. 13 in accordance with a preferred embodiment of the present invention. The injection mold will have a core 1402 of a flexible, preferably biocompatible material. Preferably, the core is made of silicone. The mold also contains an outer, removable shell 1301. The liquid polymer is injected into orifice 1302 into area 1401. When the polymer cools or cures, the shell 1301 is removed. The polymer may be removed from the silicone core in a method consistent with the method described above for FIG. 12.

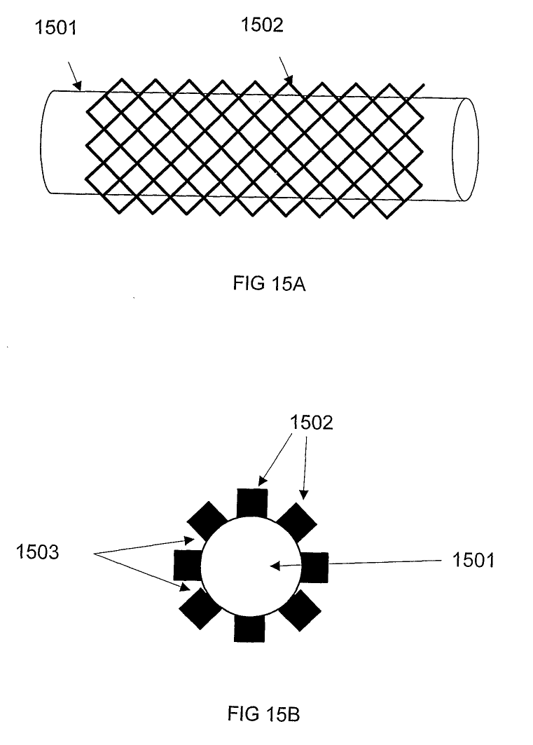

In another preferred embodiment, a mold is created by use of a core cylinder of silicone presented in FIG. 15A as 1501. A three-dimensional stent 1502 having a pattern of struts desired for the final stent is placed upon the cylinder 1501. The stent 1502 may be made of any material that is resistant to high heat but preferably, the stent is metal. The inner diameter of the stent 1502 should by very close to the outer diameter of the cylinder 1501 such that there is minimal space between the inner diameter of the stent and the outer diameter of the silicone cylinder. FIG. 15B depicts a cut of a cross-section of the pattern of FIG. 15A in accordance with a preferred embodiment of the present invention. Once the stent 1502 is placed on the cylinder 1501, there are open spaces 1503 created by the struts of the stent 1502.

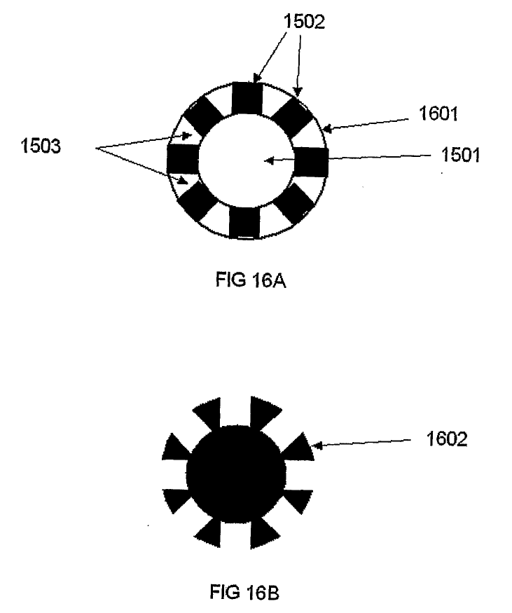

In FIG. 16A, the pattern is then placed within a chamber 1601 which has an inner diameter that is very close to the outer diameter of the stent 1502 such that there is minimal space between the outer diameter of the stent 1502 and the inner diameter of the chamber 1601. The chamber may be in any form as long as the inner diameter of the chamber is very close to the outer diameter of the stent. Further, the chamber may be made of any heat resistant material. Silicone material is heated until it is above the glass transition temperature and poured into, pushed into or injected into the empty spaces 1503 created by the struts of the stent 1502. In an alternate embodiment, the silicone is in the form of a powder or fine grains that are poured into the empty spaces 1503 whereby the pattern and chamber 1601 are then heated above the glass transition temperature. The silicone is allowed to cool and harden within the mold, which results in the silicone fusing with the cylinder 1501. Once the chamber 1601 is removed, the resulting mold shown in FIG. 16B may be used to make biodegradable stents with the same strut pattern as the metal stent 1502.

It is further contemplated that any step of the discussed methods of stent production be automated. In one preferred embodiment, all steps of the methods of stent production are automated.

Optionally, the polymeric layer used to make the stent impregnated with an anticoagulant agent, such as heparin, anti-oxidants, such as vitamin E, compounds that regulate cellular proliferation, or anti-inflammatory drugs, such as corticosteroids, to provide localized drug delivery. Such drugs are incorporated into the polymeric layer using techniques known in the art. Agents may also be incorporated into the base polymer that forms the body of the stent, as long as the incorporation does not have significant adverse effects on the desired physical characteristics of the stent such as during radial stent deployment and degradation time. For intravascular stents, it is preferred that the film has a thickness of from about 0.05 mm to 0.2 mm.

Further, in some embodiments, the stent may be coated with or the polymer of the stent may comprise compounds that modulate wound healing. Generally, compounds that modulate wound healing may be any compound that cross links with fibrin to provide matrix for cell adhesion and migration; functions as an early component of the extracellular matrix or assists in matrix formation; binds to collagen and interacts with matrix glycosaminoglycans; has chemotactic properties for macrophages, fibroblasts and endothelial and epidermal cells; promotes opsonization and phagocytosis; forms a component of the fibronexus; forms scaffolding for collagen deposition; or functions otherwise to promote healing.

Examples of compounds that promote wound healing include, but is not limited to, proteases; vasoactive substances such as serotonin and histamine; fibronectin; collagenases; plasminogen activator; neutral proteases; elastin; collagens; proteogycans such as chondroitin-4-sulfate, dermaten sulfate and heparin sulfate; sulfated and non-sulfated glycosaminoglycans; epidermal growth factor (EGF); hormones such as estradiol, testosterone or progesterone; macrophage derived growth factor (MDGF); platelet derived growth factor (PDGF); thrombin; insulin; certain lymphokines; vascular endothelial growth factor (VEGF); fibroblast growth factors; co-factors such as iron, copper, and vitamin C; adrenomedullin; angiogenin; angiopoietin-1; angiopoitin-related growth factor; brain derived neurotrophic factor; corticotropin-releasing hormone; Cyr16; erythropoietin; follistatin; hepatocyte growth factor; interleukins (IL-3, IL-8); midkine; neurokinin A; neuropeptide Y (NPY); pleiotrophin; progranulin; proliferin; secretoneurin; substance P; transforming growth factor; VG5Q; factors that recruit pericytes; and becaplermin.

Generally, the struts are arranged in patterns that are designed to contact the lumen walls of a vessel and to maintain the general structure of the vessel thereby. A myriad of strut patterns are known in the art for achieving particular design goals. Including designs that when expanded in the body will create multiple branches and/or openings.
It is contemplated that a stent may incorporate slits or open spaces to allow for the crimping to temporary reduction in diameter of the cylindrical tube without substantially altering the wall thickness. Moreover, a stent embodying the present invention can include teeth and corresponding catching structure that operates to maintain an expanded form. Moreover, polymer based stents embodying structure defined by a wire or ribbon coil or helix or a knitted mesh configuration are possible examples of self-expanding stents. Other important design characteristics of stents include radial or hoop strength, expansion ratio or coverage area, and longitudinal flexibility. One strut pattern may be selected over another in an effort to optimize those parameters that are of importance for a particular application.

It is also contemplated that the biodegradable stent may have a programmed pattern of in vivo degradation. Stent polymeric structure allows for differential speed degradation. See, for example, U.S. Pat. No. 5,957,975, the entirety of which is incorporated by reference. In one embodiment, the stent comprises at least one substantially cylindrical element having two open ends and a plurality of regions circumferentially spaced around the cylindrical element and extending from one open end to the other open end of the cylindrical element. Each of the regions is configured or designed to have a desired in vivo lifetime. At least one of the regions is designed to have a shorter in vivo lifetime than the other region or regions. This means that the region having the shorter in vivo lifetime degrades sooner after deployment than the regions having a longer in vivo lifetime. Thus, when stents designed in accordance with the present invention are deployed within the lumen of a vessel of a patient, the cylindrical element acquires one or more fissures which extend from one open end of the cylindrical element to the other open end of the cylindrical element within a desired, predetermined period of time after the stent is deployed in the patient. It has been determined that such dismantling, or fragmentation, within a predetermined period of time after deployment allows for enlargement of the lumen of the vessel via the process of arterial remodeling.

The regions of the stent with the different in vivo lifetimes can be made in a variety of ways. Preferably, such stents are made by producing regions having a first in vivo lifetime, i.e., a shorter in vivo lifetime, in a polymeric layer having the predetermined second, or longer, in vivo lifetime. The regions having the first in vivo lifetime are produced by heating the respective regions of the polymeric layer having a second in vivo lifetime for a time and at a temperature sufficient to cause local partial degradation of the polymeric chains. Such treatment, which can be accomplished using a piloted hot needle, laser beam, or flow of hot air, renders the polymer in the heated region more sensitive to hydrolytic degradation. Alternatively, the regions having a first in vivo lifetime may be produced in a polymeric layer having a second in vivo lifetime by incorporating a sufficient number of acidic ions into the respective regions of the polymeric layer. Preferably, the acidic ions are provided by compounds that are not soluble in blood.

Regions having a first in vivo lifetime can also be produced in a polymeric film having a second in vivo lifetime by exposure of the respective regions to beta radiation or gamma radiation for a sufficient time to induce partial cleavage of the polymeric chains within the respective regions. Provided the polymeric layer has a thickness of less than 0.3 mm, regions having a first in vivo lifetime can also be produced in a polymeric film having a second in vivo lifetime by introducing areas of mechanical weakness into the polymer. One method of introducing mechanical weakness is by reducing the thickness of the polymer in the respective region or forming holes therein. Regions having a first in vivo lifetime can also be produced in a polymeric film having a second in vivo lifetime by applying mechanical stress to the respective region. However, this latter process is more difficult to control and, thus, is less preferred. Differing lifetimes can also be created by providing one or more different coatings over different regions of the biodegradable stent.

The initial polymeric cylindrical device that is formed by any of these processes can be configured to have the final predetermined shape, length, wall thickness and diameter, all of which are tailored to the application for which the stent is to be utilized. For example, for cardiovascular applications the initial polymeric device that is formed by these processes can have a final predetermined length ranging from 0.5 cm to approximately 3 cm. For certain applications, the initial polymeric cylindrical device can have a final, predetermined diameter ranging from 0.50 mm to 8.0 mm with a final, predetermined wall thickness ranging from 0.05 to 0.5 mm. Alternatively, the initial cylindrical device that is formed by any of these processes can have a smaller diameter than the final predetermined diameter.

In those instances where the initial polymeric cylindrical device has a smaller diameter than the final predetermined diameter, slits or openings are formed in the cylindrical device as described above, and then the cylindrical device is deformed or expanded to the final shape and diameter. This can be achieved by inserting an expandable device such as a balloon into the stent.

Once the stent is formed, the stent is preferably immersed in a bath comprising at least acetone and then dried. Immersion of the stent into the bath decreases any sharp surfaces and irregularities, as determined by scanning electron microscopy. The stents can be dried by any means, but preferably, the stents are dried at atmospheric pressure until they achieve a constant weight. Complete drying may be verified by measuring the residual acetone by gas chromatography or by thermo gravimetric analysis.

The acetone bath step is generally conducted at a temperature that is below the glass transition temperature of the polymer that forms the stent. Preferably, the acetone bath step is conducted at a temperature of below 65° C., more preferably below 60° C., most preferably below 55° C. In certain embodiments, a temperature below about 50° C. is most preferred. It is preferable to use a temperature that is below the glass transition temperature of the stent as this results in reducing the exposure of the stent to adverse temperature conditions.

If the surface tension of the solvent used in the solvent bath is too high, it may inhibit solvent entry into the inner surface of the stent, leading to variation in the properties of the stent over its length. If desired, this can be avoided by manipulation of the atmospheric pressure over the solvent bath, adding agents to the bath to reduce the surface tension of the solvent, agitation or altering flow through the lumen of the stent.

The acetone concentration in the bath can be any concentration determined by one skilled in the art to decrease the sharp edges and irregularities of the stent, decrease the surface reactivity of the stent, and/or decrease the reactive amino groups. It is preferred that the same polymer used in the stent is also dissolved in the acetone bath at a concentration of at least about 0.05% weigh/volume, and is most preferably at least about 5% weight/volume.

In addition, certain embodiments of the invention provide for the addition of poly (lactic) acid (PLA), poly-L-lactide, poly-DL-lactide, L-lactide monomers and/or DL-lactide monomers to the acetone bath. It is further contemplated to add one or more polyethers to the acetone bath. It is contemplated that the polyethers may include, but is not limited to, polyethylene glycol, polyethylene oxide, crown ethers, or mixes thereof. Preferably, the polyether added to the acetone bath is polyethylene glycol (PEG). In one preferred embodiment, the acetone bath contains PLA-PEG diblock copolymers. The concentration of PLA and/or PLA-PEG diblock copolymers is greater than about 0.1% weight/volume, preferably greater than about 10% weight/volume, and more preferably about 5% weight/volume. It is also understood that the acetone bath may contain other polymers, compounds and/or chemicals that are also included in the composition of the stent. For instance, if the stent polymer contains a biodegradable polymer such as polycaprolactone, polyglycolide, poly-3-hydroxybutyrate, polyglycolide, poly (D, L-lactide), copolymers of lactide and glycolide, polycaprolactone, polyhydroxyvalerate, polyhydroxybutyrate, polytrimethylenecarbonate, polyorthoesters, polyanhydrides, polyphosphazenes, or mixes thereof, the polymer(s) may also be added to the acetone bath.

Further, it is contemplated that other solvents may be used instead of acetone or may be included with the acetone in the bath. For instance, solvents that may be used in the bath includes one or more types of chlorinated or halogenated hydrocarbons. The chlorinated hydrocarbons contemplated includes, but is not limited to: dichloromethane, 1,1,1-trichloroethane, 1,1,2-trichloroethane, 1,1-dichloroethane, trichloroethlene, lindane, polychlorinated biphenyls, dioxins, furans, perchloroethylene, chloroform, methoxychlor, hexachlorocyclohexane, chlordane, dieldrin, heptachlor, methoxychlor, toxaphene, carbon tetrachloride, or mixtures thereof.

It is also contemplated to use solvents from the ketone family instead of acetone or included with acetone in the bath. Members of the ketone includes organic compounds that contain a carbonyl group that is bonded to only carbon atoms. The ketones contemplated includes, but is not limited to: acetoacetate, acetophenone, butanone, C-11 ketone, cyclohexanone, diacetone alcohol, diisobutyl ketone, isophorone, methyl amyl ketone, methyl ethyl ketone, methyl isoamyl ketone, methyl isobutyl ketone, beta-hydroxybutyrate, or mixes thereof. Other useful solvents and mixtures thereof that can be utilized in the baths include the aldehydes, which could also help to stabilize certain polymers used in the stents. In some embodiments, drugs or compounds that modulate coagulation or wound healing may be added to the bath. Further, the step of the acetone bath can occur at any point during the fabrication of the stent. Preferably, the step of the acetone bath occurs at the end of the stent fabrication. More preferably, the step of the acetone bath occurs before the stent is educated.

### II. Exemplary Educating and Crimping of the Stent

While it is at the final predetermined shape, size, and diameter, the cylindrical stent device is educated by heating the device to a temperature above the Tg of the polymer from which the device is formed. The device is heated for a time sufficient to erase former process-related memory and to impart a new memory of the final predetermined shape and diameter to the polymeric cylindrical device. It is believed that such conditions allow the polymer chains to relax and reorganize themselves from an entanglement typical of the former processing stages to an entanglement typical of the high temperature at which the cylindrical device is compatible with the final or deformed shape and size. When the polymeric cylindrical device has an initial diameter that is less than the final predetermined diameter, it is desired to heat to a temperature well above the Tg of the polymer. This heating step erases the anisotropic stresses promoted by the extrusion or molding process and the former processing-related memory of the polymer chains. Good results have been obtained by heating a laser-precut polymeric cylindrical device formed from PLA75 and deformed from a diameter of 1.0 mm to 4 mm at a temperature of 80° C. for 30 minutes. Temperatures of from about 45° C. to about 120° C. and times of 5 minutes or more should be suitable for educating stents made from PLAx with 0<X<100, PLAxGAy with 0<X<25 and 75<Y<100, or any PLAxGAyGLz.

The polymeric cylindrical device is then crimped. “Crimping” as used herein refers to a process that involves radial pressing on a polymeric cylindrical device having slits, or openings in the wall thereof to allow a decrease in the diameter of the device without substantially affecting the thickness of the wall or struts of the cylindrical device. Such process may also result in an increase in length of the cylindrical device.

To crimp the educated cylindrical device, it is mounted onto a device with a smaller diameter. The diameter of the educated cylinder is reduced by heating the cylinder to a temperature below the Tg of the polymer while evenly applying pressure on the exterior surface of the wall of the cylindrical device.

In some embodiments, the polymeric stent is crimped onto an inflatable device such as an inflatable balloon catheter. In this instance, the stent assembly after crimping comprises an inflatable balloon catheter and an expandable, educated, polymeric stent snugly and stably disposed thereon. Slits or open spaces that allow for a reduction in diameter of the cylindrical device without substantially altering the wall thickness during crimping are incorporated into the cylindrical device prior to the time the cylindrical device is crimped on the inflatable balloon catheter. The temperature at which the cylindrical device is heated during crimping is high enough to allow reduction in diameter of the cylindrical device but low enough to not erase the memory of the final predetermined shape and diameter of the educated cylindrical device. Ideally, the temperature is less than the glass transition state of the polymer. More preferably, the temperature is at about 50° C. Thus, the temperature at which the educated cylindrical device is heated during crimping is less than the temperature at which the cylindrical device is heated during education of the cylindrical device. Further, the time it takes to crimp the educated cylindrical device can vary, depending upon the temperature, size and composition of the stent.

In accordance with the present method, expansion of the polymeric stent can be achieved by any means. In one embodiment, a balloon is used merely as a carrier for the stent through the body. In this preferred embodiment, the stent expansion occurs by the positive recoil properties of the stent; thus, the expansion is balloon inflation independent. In another preferred embodiment, a balloon is inflates and/or heated to initiates the stent expansion. It is contemplated that the positive recoil properties of the stent expand the stent to its final predetermined diameter. The temperature used to initiate the stent expansion may be any temperature at or below the Tg of the polymer, preferably the temperature is about body temperature. In a less preferred embodiment, a balloon is inflated to expand the polymeric stent to its final predetermined shape.

In another aspect, the method of the present invention starts with a polymeric tube whose diameter initially is less than the final predetermined diameter. Such tube is first heated to a temperature close to or above the Tg of the polymer and expanded to provide a cylindrical device whose diameter is equal to the final desired diameter. Thereafter the cylindrical device is educated as described above to provide an educated cylindrical device having a memory of the final predetermined shape and diameter, and then crimped on a balloon catheter as described above to provide an assembly comprising the balloon catheter and an expandable, educated, polymeric stent snugly and stably disposed thereon.

The present invention also provides an assembly comprising an inflatable balloon catheter and a polymeric stent prepared in accordance with the present method.

Preferably, the stent of the present invention exhibits little to no relaxation-related negative recoil when deployed in the blood vessel of a subject. Advantageously, the assembly of the present invention has a diameter that allows it to be easily inserted into a blood vessel of the subject and advanced to a target site. Preferably, the stent of the present invention exhibits expansion (positive recoil) and adaptation to the geometry of the artery when the stent is not fully deployed up to its final diameter during deployment. Positive recoil over several days will create outward radial pressure for long periods of time. This outward radial pressure aids in positive vascular remodeling by assisting stabilizing the injured artery or vulnerable plaque, assist in cellular progress to repair injury of original acute expansion, assist in security of tissue flaps, and the like.

In addition, the stent of the present invention is stably disposed on the balloon, meaning that a mechanical restraint is not required to prevent the stent from rapidly expanding to its final diameter during storage at room temperature. Thus, although not required, the assembly of the present invention, optionally, also comprises a retractable sheath covering the exterior surface of the stent. Such sheath serves to prevent deformation of the stent and preclude or slow expansion during storage.

### III. Exemplary Procedures for Determining Times and Temperatures for Educating and Crimping the Stent of the Present Invention

Temperatures and times suitable for educating the cylindrical device and for thereby developing a stent that resistant to negative recoil, and in fact has positive recoil, can be assessed by first crimping the stent of the present invention onto a balloon catheter. The balloon is then inflated to initiate stent expansion. The balloon is removed and the stent is stored at 37° C. While in storage, the stent may increase in diameter because of the positive recoil properties of the stent. If the stent exhibits little to no negative recoil when stored under these conditions for 4 to 6 weeks or, preferably the time estimated for an artery wall to recover from PTC angioplasty, the times and temperatures employed for educating the stent are suitable. In those cases where the polymeric stent exhibits a small amount of recoil, the cylindrical device is preferably educated at a diameter slightly larger than the final predetermined diameter to compensate for the small amount of negative recoil.

Temperatures and times suitable for crimping the stent to a reduced diameter can be assessed by allowing the stent-mounted balloon catheter of the present assembly to stay at room temperature or at the storage temperature. If the crimped stent stays collapsed at the small diameter corresponding to the deflated balloon under these conditions, the times and temperatures employed during crimping are suitable.

Optimization of the imparted stent mechanical properties such as positive recoil can be achieved by storing the finished product at a room temperature below 20° C. Preferably, the finish product is refrigerated at about 6° to 8° C.

### IV. Deployment of the Stent

The polymer-based stent is first preheating for a period of 3 to 6 min at around 37° C. The preheating of the stent can occur by any means, including heating in saline, the in vivo blood stream, or hot air. After the preheating period, the polymer-based stent assembly of the present invention is introduced into a duct, tube, or vessel, e.g., a blood vessel of a mammalian subject, preferably in conjunction with a guiding catheter, and advanced to a target site, e.g., the site of stenotic lesion. After it is located at the target site the balloon is rapidly inflated to initiate expansion of the stent. Alternatively, the stent may be placed on a deployment device that is capable of localized heating of the stent when the stent is correctly positioned. During this process the diameter of the stent increases, but the thickness of the walls of the stent remain substantially the same.

It is further contemplated that fracturing of the plaque and deployment of the stent may be done concurrently. If a balloon is used in such cases, the balloon is inflated to a pressure of about 8 to 12 atmospheres to crack the plaque and expand the stent. Alternatively, the vessel may be pre-dilated using angioplasty without the stent. Thereafter, the stent is introduced into the desired site on a separate catheter, preferably an expanding balloon catheter.

In addition to coronary arteries, the present stent may be used in other arteries such as for example, femeroiliac arteries, the carotid artery, vertebro-basilar arteries, as well as in the interior of other hollow passageways such as for example veins, ureters, urethrae, bronchi, biliary and pancreatic duct systems, the gut, eye ducts, and spermatic and fallopian tubes. Indeed, it is further contemplated that certain aspects of the present invention include devices that are used as substitutes for veins, arteries, and ductal or tubal structures in the body.

While only the presently preferred embodiments have been described in detail, as will be apparent to those skilled in the art, alternatives, additions, modifications and improvements maybe made to the device and method disclosed herein without departing from the scope of the invention. Accordingly, it is not intended that the invention be limited, except as by the appended claims.

1-25. (canceled)

26: A method of manufacturing a stent using a reverse mold, said method comprising:
placing a three dimensional stent upon a cylinder to create a pattern, whereby there is minimal space between the inner diameter of the stent and the outer diameter of the cylinder;
placing the pattern within a first casting chamber;
heating a casting material until it enters an aqueous state;
injecting the liquid casting material into the first casting chamber;
cooling the casting material until it hardens;
removing the pattern and cylinder from the first casting chamber, whereby the hardened first liquid casting material forms a reverse mold;
placing a second cylinder inside the interior diameter of the reverse mold, whereby there is a predetermined amount of space between the interior diameter of the reverse mold and the outer diameter of the second cylinder, and placing the reverse mold within a second casting chamber;
heating a polymer unit the temperature of the polymer is above the glass transition temperature of the polymer;
placing the polymer within the second casting chamber such that the polymer fills at least part of the space between the reverse mold and the second cylinder;
cooling the polymer until the temperature of the polymer is below the glass transition temperature of the polymer, and;
releasing the cooled polymer from the mold, whereby the cooled polymer is in the shape of the stent.

27: The method of claim 26, wherein at least one liquid casting material is biocompatible.

28: The method of claims 26, wherein the polymer is biodegradable, biocompatible, and/or bioresorbable.

29: The method of claim 28, wherein the polymer is selected from the group consisting of: poly(L-lactide), polyglycolide, poly(D,L-lactide), copolymers of lactide and glycolide, polycaprolactone, polyhydroxyvalerate, polyhydroxybutyrate, polytrimethylenecarbonate, polyorthoesters, polyanhydrides, polyphosphazenes, polylactic acid, polyglycolic acid, polyglactin, polyglyconate, lactic acid-based stereocopolymers, copolymers of lactic and glycolic acids, and Poly(lactic-co-glycolic-co-gluconic acid).

30: The method of claim 26, wherein the glass transition temperature of the polymer is at least 45° C.

31: The method of claim 26, wherein the glass transition temperature of the polymer is at least 57° C.

32: The method of claim 26, wherein the polymer is released from the reverse mold by physical manipulation of the mold.

33: The method of claim 32, wherein removing the stent from the reverse mold comprises:
removing the second cylinder from the reverse mold; and,
applying an outward force to more than one edge of the reverse mold, such that the length of the mold increases, generating an increase in transverse force that decreases the radius of the mold.

34: The method of claim 26, wherein the polymer is released from the mold by air jets.

35: The method of claim 26, wherein the polymer is released from the mold by the difference in temperature expansion coefficients between the polymer and the mold.

36: The method of claim 26, wherein at least one casting material is silicone.

37: The method of claim 26, wherein the released polymer is a two dimensional sheet.

38: The method of claim 37, further comprising joining the edges of the two dimensional polymer sheet to form a cylinder.

39: The method of claim 38, wherein at least one edge of the two dimensional polymer sheet has one or more projections.

40: The method of claim 38, wherein the one or more projections comprise a distal catch mechanism.

41: The method of claim 26, wherein the reverse mold is two dimensional.

42: The method of claim 26, wherein the reverse mold is three dimensional.

43: The method of claim 26, whereby at least one method step is automated.

44: The method of manufacturing a stent using a reverse mold by at least one automated step, said method comprising:
i) manufacturing a reverse mold by:
a) placing a three dimensional stent upon a first cylinder composed at least partially of silicon, whereby the stent and first cylinder combine to form a pattern, whereby there is minimal space between the inner diameter of the stent and the outer diameter of the cylinder;
b) placing the pattern within a casting chamber that has a cylindrical interior, whereby there is minimal space between the interior diameter of the casting chamber and the outer diameter of the stent;
c) heating a casting material composed at least partially of silicon until it enters an aqueous or gelatinous state;
d) injecting the casting material into the first casting chamber;
e) cooling the casting material until it hardens;
f) removing the stent from the first casting chamber, whereby the hardened silicon and silicon cylinder form a reverse mold,
ii) placing the reverse mold against a concave curved device such that there is minimal space between the outer diameter of the reverse mold and the inner diameter of the concave curved device;
iii) heating a biodegradeable, biocompatible, and/or bioresorable polymer until it enters an aqueous state;
iv) placing the aqueous polymer into the spaces of the reverse mold as the reverse mold rotates along its axis;
v) cooling the polymer such that it hardens; and
vi) removing the polymer from the reverse mold where at least one step i)-vi) is automated.

45: The method of claim 44, wherein the polymer is selected from the group consisting of: poly(L-lactide), polyglycolide, poly(D,L-lactide), copolymers of lactide and glycolide, polycaprolactone, polyhydroxyvalerate, polyhydroxybutyrate, polytrimethylenecarbonate, polyorthoesters, polyanhydrides, polyphosphazenes, polylactic acid, polyglycolic acid, polyglactin, polyglyconate, lactic acid-based stereocopolymers, copolymers of lactic and glycolic acids, and Poly(1 actic-co-glycolic-co-gluconic acid).

46: The method of claim 44, wherein the glass transition temperature of the polymer is at least 45° C.

47: The method of claim 44, wherein the polymer is released from the reverse mold by physical manipulation of the mold.

48: The method of claim 47, wherein removing the stent from the reverse mold comprises:
removing the second cylinder from the reverse mold; and,
applying an outward force to more than one edge of the reverse mold, such that the length of the mold increases, generating an increase in transverse force that decreases the radius of the mold.

49: The method of claim 44, wherein the polymer is released from the mold by air jets.

50: The method of claim 44, wherein the polymer is released from the mold by the difference in temperature expansion coefficients between the polymer and the mold.
